(19) United States
(12) Patent Application Publication
(10) Pub. No.: US 2025/0172147 A1
(43) Pub. Date: May 29, 2025

(54) SUBMERSIBLE PUMP MOTOR DRIVE INCLUDING OUTPUT CLAMPING FILTER

(71) Applicant: Franklin Electric Co., Inc., Fort Wayne, IN (US)

(72) Inventors: Benjamin W. Hunley, Yoder, IN (US); Jason L. Coney, Columbia City, IN (US); Justin A. Anteau, Roanoke, IN (US)

(21) Appl. No.: 18/523,036

(22) Filed: Nov. 29, 2023

(51) Int. Cl. F04D 13/08; F04D 15/00; H02M 1/12

(52) U.S. Cl. CPC F04D 13/086; F04D 15/0077; H02M 1/126

(57) ABSTRACT

A clamp filter is provided for attenuating high voltage ring up and reflections in an output of a variable frequency drive for deep well pump applications where an output of the variable frequency drive is connected to a remote pump motor by a cable. The filter includes an inductor, a resistor, a first diode and a second diode. The inductor has an input side connected to an AC output voltage of an inverter and an output side connected to an input side of the resistor. The resistor has an output side connected to a cathode of the first diode and an anode of the second diode. An anode of the first diode is connected to a common point, and a cathode of the second diode is connected to a +DC line.

### FIELD

The present disclosure pertains to pump systems, and more particularly to pump systems using remotely located variable frequency drives.

### BACKGROUND

It is known that when driving a remote motor of a pump system over a long cable using a variable frequency drive, it is desirable to attenuate high voltage ring up and reflections developed at the motor terminals. Past standard solutions with typical variable frequency drives for remote motor applications use an LCR filter topology comprising inductors, capacitors and resistors as depicted in FIG. 1. These filter topologies are usually less effective at long motor cable lengths, or if made effective, are much more expensive due to the larger components required and are typically impractical due to size and power dissipation.

Other known filter topologies, such as that shown in FIG. 2, attenuate the voltage ring up and reflections at the motor terminals and limit the dv/dt. Such topologies, however, do not include resistors for damping and surge protection and require capacitors to achieve a peak voltage and dv/dt target. The lack of surge protection implies this topology is susceptible to failure due to surge transients coupled to the output cable of the drive.

Other derivatives of the topology omit the capacitors. Instead, the capacitance is derived from utilizing specific higher reverse recovery charge diodes to manifest capacitance, thereby meeting a dv/dt and peak voltage target. Such topologies, however, typically suffer from the same surge transient weakness. Furthermore, such an approach leads to more power dissipation in the diodes due to greater reverse recovery losses.

Still other derivatives use damping resistors, such as the topology depicted in FIGS. 3 and 4. The damping resistors in these topologies may provide damping to the filter, but the locations of the resistors mean the diodes are still highly susceptible to failure due to surge transients coupled to the output motor cable.

Thus, it is desirable to provide an approach that permits the motor drive electronics to be remotely located from the motor while also preventing high voltage stress on the motor windings due to transmission line ring up and reflections and reduce ball bearing wear due to high dv/dt capacitive currents in surface pumping applications. It is also desirable to reduce the cost associated with motor drive electronics remotely located from the motor while driving single phase motors that utilize built-in start switches by keeping voltage ring up and reflections at the motor terminals attenuated. When high voltage rings up and reflections occur at a single-phase motor start switch, the high voltage spikes can cause false triggering of the switch during operation, which can lead to undesirable motor behavior and, in some cases, start switch failure. Finally, it is desirable to improve immunity to surge transients coupled to the drive output cables.

### SUMMARY

According to one embodiment of the present disclosure, a pump system is provided, comprising: a power source; a pump unit including a pump and a motor; a motor drive disposed remotely relative to the pump unit; and a cable connecting the motor drive to the motor; the motor drive comprising: a rectifier coupled to the power source and configured to convert alternating current (“AC”) voltage from the power source into a direct current (“DC”) output voltage having a +DC line and a −DC line; an inverter coupled to the rectifier and configured to convert the DC output voltage of the rectifier into an approximated AC output voltage; and a clamp filter coupled to the inverter configured to attenuate high voltage ring up and reflections developed at input terminals of the motor; wherein the clamp filter includes for each phase of the approximated AC output voltage, an inductor, a resistor, a first diode having an anode and a cathode and a second diode having an anode and a cathode, the inductor having an input side connected to the AC output voltage and an output side connected to an input side of the resistor, the resistor having an output side connected to the cathode of the first diode and the anode of the second diode, the anode of the first diode of each phase being connected to a common point, and the cathode of the second diode being connected to the +DC line. In one aspect of this embodiment, the rectifier is configured to covert three-phase AC voltage from the power source. In another aspect, the inverter is configured to convert the DC output voltage of the rectifier into an approximated three-phase AC output voltage. In a variant of this aspect, the clamp filter includes, for each phase of the approximated three-phase AC output voltage, an inductor, a resistor, a first diode having an anode and a cathode and a second diode having an anode and a cathode, the inductor having an input side connected to one phase of the approximated three-phase AC output voltage and an output side connected to an input side of the resistor, the resistor having an output side connected to the cathode of the first diode and the anode of the second diode, the anode of the first diode of each phase being connected to the common point, and the cathode of the second diode being connected to the +DC line. In yet another aspect, the system further comprises a surge protector connected between the clamp filter and the cable, the surge protector including a first metal oxide varistor having an input side connected to the output side of the inductor and an output side connected to an input side of a common metal oxide varistor, an output side of the common varistor being connected to earth ground. In a variant of this aspect, the resistor has a resistance value that when multiplied by an expected maximum surge current is greater than a clamp voltage of the surge protector. Another aspect further comprises a current sense shunt resistor having a first end connected to the −DC line and a second end connected to the common point of the clamp filter to detect a failure of at least one of the first diode and the second diode. Yet another aspect further comprises a capacitor having a first end connected to the +DC line and a second end connected to the −DC line, the capacitor being configured to smooth ripples on the DC output voltage of the rectifier. In still a further aspect of this embodiment, the pump unit is a deep well pump unit. In a variant of this aspect, the cable has a length of between approximately 25 feet and 1,000 feet.

In another embodiment, the present disclosure provides a clamp filter for attenuating high voltage ring up and reflections in an output of a variable frequency drive for deep well pump applications where an output of the variable frequency drive is connected to a remote pump motor by a cable, the clamp filter comprising: for each phase of an approximated AC output voltage of the variable frequency drive, an inductor, a resistor, a first diode having an anode and a cathode and a second diode having an anode and a cathode, the inductor having an input side connected to an AC output voltage of an inverter and an output side connected to an input side of the resistor, the resistor having an output side connected to the cathode of the first diode and the anode of the second diode, the anode of the first diode being connected to a common point, and the cathode of the second diode being connected to a +DC line. In one aspect of this embodiment, the inverter is configured to convert a DC output voltage of a rectifier into an approximated three-phase AC output voltage, and the clamp filter includes, for each phase of the approximated three-phase AC output voltage, an inductor, a resistor, a first diode having an anode and a cathode and a second diode having an anode and a cathode, the inductor having an input side connected to one phase of the approximated three-phase AC output voltage and an output side connected to an input side of the resistor, the resistor having an output side connected to the cathode of the first diode and the anode of the second diode, the anode of the first diode of each phase being connected to the common point, and the cathode of the second diode being connected to the +DC line. In another aspect, the filter further comprises a surge protector connected between the clamp filter and the cable, the surge protector including a first metal oxide varistor having an input side connected to the output side of the inductor and an output side connected to an input side of a common metal oxide varistor, an output side of the common varistor being connected to earth ground. In a variant of this aspect, the cable has a length of between approximately 25 feet and 1,000 feet. In a further variant, the resistor has a resistance value that when multiplied by an expected maximum surge current is greater than a clamp voltage of the surge protector. Another aspect further comprises a current sense shunt resistor having a first end connected to a −DC line and a second end connected to the common point of the clamp filter to detect a failure of at least one of the first diode and the second diode.

In yet another embodiment, the present disclosure provides a deep well fluid pump system, comprising: a deep well pump unit disposed in a well and including a pump and a motor; a variable frequency drive disposed remotely relative to the pump unit; and a cable connecting the variable frequency drive to the motor; wherein the variable frequency drive comprises: a rectifier; an inverter coupled to the rectifier by a DC link and configured to produce an approximated AC output voltage; a clamp filter coupled to the inverter; a surge protector coupled between the clamp filter and the cable; and a shunt resistor coupled between the DC link and the clamp filter; wherein the clamp filter includes for each phase of the approximated AC output voltage, an inductor, a resistor, a first diode having an anode and a cathode and a second diode having an anode and a cathode, the inductor having an input side connected to the AC output voltage and an output side connected to an input side of the resistor, the resistor having an output side connected to the cathode of the first diode and the anode of the second diode, the anode of the first diode of each phase being connected to a common point, and the cathode of the second diode being connected to a +DC line of the DC link. In one aspect of this embodiment, the rectifier is coupled to a power source and configured to convert three-phase alternating current (“AC”) voltage from the power source into a direct current (“DC”) output voltage having the +DC line and a −DC line. In a variant of this aspect, the inverter is configured to convert the DC output voltage of the rectifier into an approximated three-phase AC output voltage. In a further variant, the clamp filter includes, for each phase of the approximated three-phase AC output voltage, an inductor, a resistor, a first diode having an anode and a cathode and a second diode having an anode and a cathode, the inductor having an input side connected to one phase of the approximated three-phase AC output voltage and an output side connected to an input side of the resistor, the resistor having an output side connected to the cathode of the first diode and the anode of the second diode, the anode of the first diode of each phase being connected to the common point, and the cathode of the second diode being connected to the +DC line. In another aspect of this embodiment, the shunt resistor has a first end connected to the −DC line of the DC link and a second end connected to the common point of the clamp filter to detect a failure of at least one of the first diode and the second diode. In another aspect, the DC link includes a capacitor having a first end connected to the +DC line and a second end connected to the −DC line, the capacitor being configured to smooth ripples on the DC output voltage of the rectifier. In still another aspect, the surge protector includes a first metal oxide varistor having an input side connected to the output side of the inductor and an output side connected to an input side of a common metal oxide varistor, an output side of the common varistor being connected to earth ground. In another aspect, the resistor has a resistance value that when multiplied by an expected maximum surge current is greater than a clamp voltage of the surge protector. In yet another aspect of this embodiment, the cable has a length of between approximately 25 feet and 1,000 feet.

### BRIEF DESCRIPTION OF THE DRAWINGS

The above-mentioned and other advantages and objects of this disclosure, and the manner of attaining them, will become more apparent, and the disclosure itself will be better understood, by reference to the following description of embodiments of the invention taken in conjunction with the accompanying drawings, wherein:

FIG. 1 is a circuit diagram of a prior art variable frequency drive for remote motor applications using an LCR filter topology;

FIG. 2 is a circuit diagram of another prior art variable frequency drive for remote motor applications;

FIGS. 3 and 4 are circuit diagrams of prior art variable frequency drives for remote motor applications using damping resistors;

FIG. 5 is a conceptual view of a pump system according to one embodiment of the present disclosure;

FIG. 6 is a block diagram of one embodiment of a motor drive according to the present disclosure; and

FIG. 7 is a circuit diagram of components of the pump system of FIG. 5 using a variable frequency drive output filter technology according to one embodiment of the present disclosure.

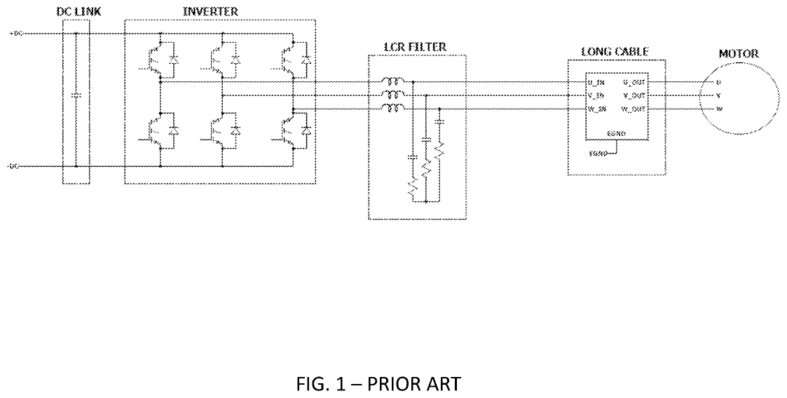

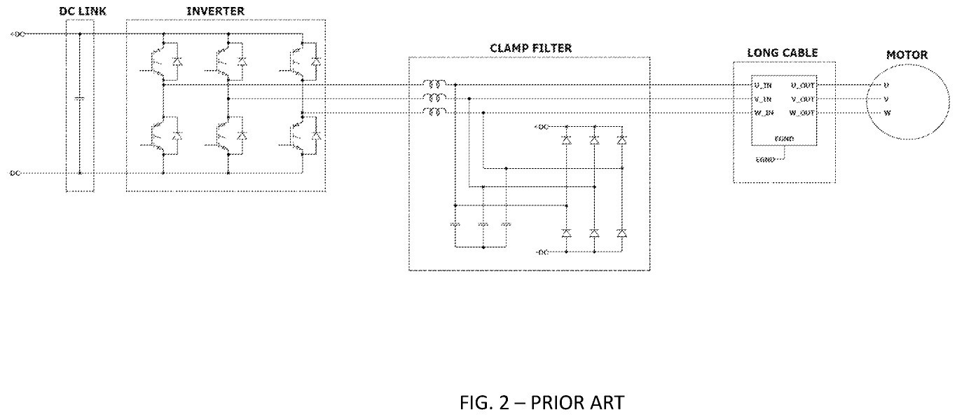

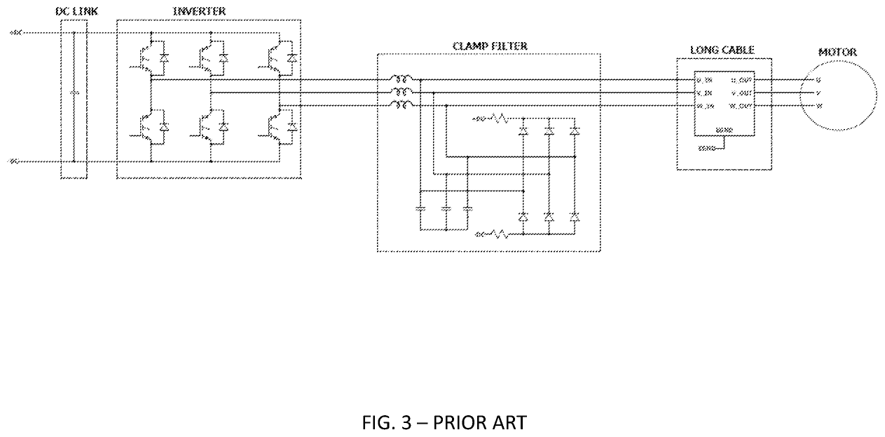

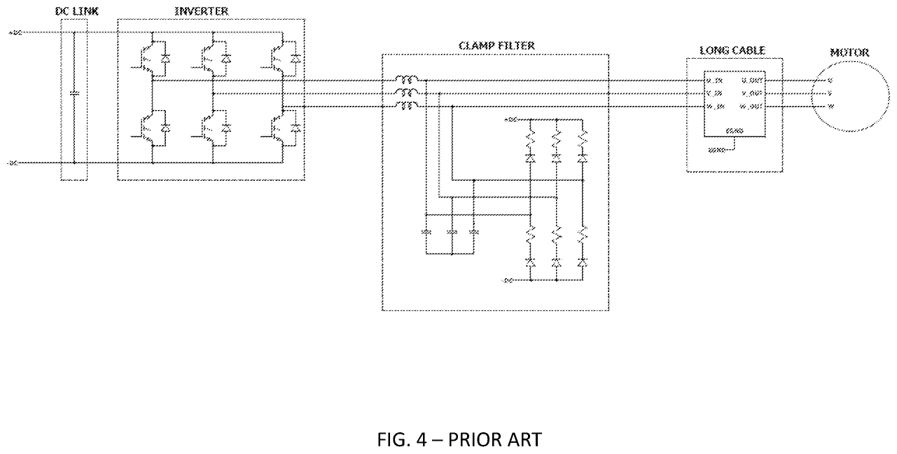

Corresponding reference characters indicate corresponding parts throughout the several views. Although the drawings represent embodiments of the present disclosure, the drawings are not necessarily to scale, and certain features may be exaggerated or omitted in some of the drawings in order to better illustrate and explain the present disclosure.

### DETAILED DESCRIPTION

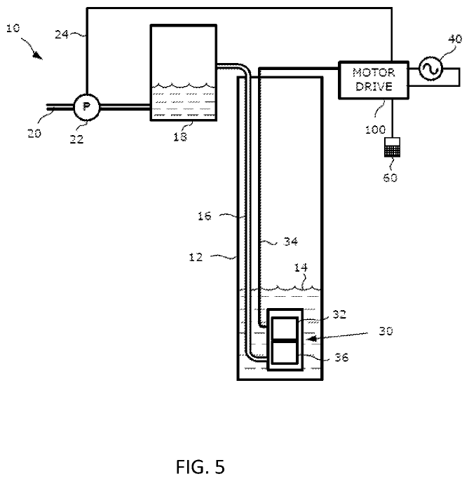

The foregoing embodiments of the disclosure, and others, will now be described with reference to the figures. Referring to FIG. 5, a diagrammatic representation of a liquid supply or pump system 10 is shown. Example liquids include water, gasoline fuel, diesel fuel, petroleum, oil, sewage, and combinations of such liquids with gases and solids, such as water and coal-based methane gas. In the description below, the liquid is referred to as water 14 and the pump is described as a deep well pump. The teachings of the present disclosure, however, apply to a variety of different applications. The liquid supply system 10 comprises a reservoir 12 containing water 14 which is pumped by a pump unit 30 through a conduit 16, optionally via another reservoir 18, e.g., a pressure tank, to a conduit 20 of a closed system. The submersible or immersive pump unit 30 includes a pump 36 driven by a motor 32 which is powered by a motor drive 100 via power conductors 34. The size of reservoir 12, which is interposed between pump unit 30 and a pressure sensor or transducer 22, affects the response of the system. In one example, the motor drive 100 is a variable frequency drive and pump 36 is a centrifugal pump. Motor drive 100 may be referred to hereinafter as “the VFD”. Power conductors 34 may comprise two or more wires to provide single or three phase power to motor 32. The teachings of the present disclosure may be used with various different types of motors 32, such as, but not limited to, three-phase induction motors, single-phase induction motors, single-phase induction motors with a start switch, and synchronous permanent magnet motors.

During operation of the system, water 14 flows out of conduit 20. For example, the system may be a water system in a home, in which case water flows out of conduit 20 when a faucet is opened or an irrigation system is turned on. Constant pressure ensures the heads of the irrigation system spray at a constant distance from the head to provide even and predictable irrigation. Fluid characteristics including pressure may be monitored with the pressure sensor 22 disposed in conduit 20 to generate a pressure signal useful to maintain pressure about a setpoint. The pressure signal is provided via line 24 connecting the pressure sensor 22 and the motor drive 100. An exemplary input device 60 is also shown. Input device 60 is provided to receive, from a user, input parameters such as setpoints and schedules. Input device 60 may comprise a smart device wirelessly coupled to motor drive 100. Example smart devices include computers, smart phones and tablets. Reservoir 12 may be an underground tank, a well casing, or any other reservoir containing water 14.

Although the embodiments may be described with reference to liquids, particularly water, the invention is not so limited. Generally, the embodiments are applicable to any rotary fluid displacement machine driven by a motor with a variable speed drive, including a variable frequency drive. As used herein rotary fluid displacement machines include pumps, fans, ventilators, turbines, radial compressors and other machines having a rotating element provided to displace a fluid.

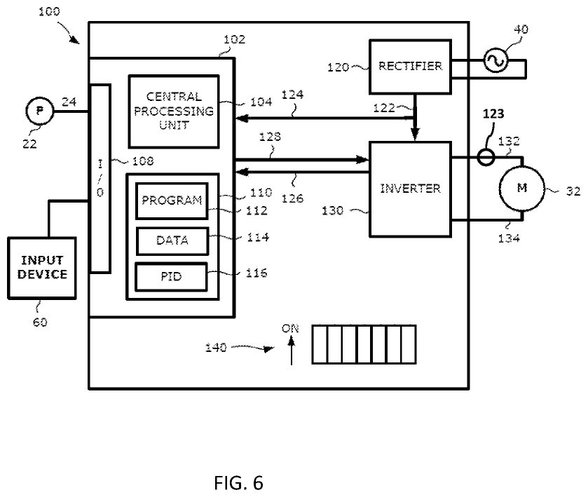

FIG. 6 illustrates an embodiment of motor drive 100 comprising a processing device, illustratively controller 102, a rectifier 120 and an inverter 130. As shown, controller 102 includes a CPU 104 configured to access a memory device 110 and execute processing instructions from a program module, exemplified by program 112, based on data 114. Another example of a program module is shown as PID module 116. PID module 116 may also be comprised in a hardware module communicatively coupled to CPU 102. Motor drive 100 further comprises a plurality of switches, which may be soft or hard switches, operable to configure motor drive 100. Dual-in-line packaged (DIP) switches 140 are shown

Techniques for generating motor voltages according to characteristics of a control signal are known in the art. In one example, a technique comprises storing values in a table corresponding to samples of an operating curve. The operating curve is typically a substantially straight line defining a volts-hertz relationship. When the speed control system determines a desired operating speed, which defines an operating frequency, the motor drive 100 looks up a voltage corresponding to the frequency. The motor drive 100 then generates a motor voltage based on the voltage and the frequency. In another example, a formula or a function embodying the operating curve characteristics is used by CPU 104 to generate the desired motor voltages.

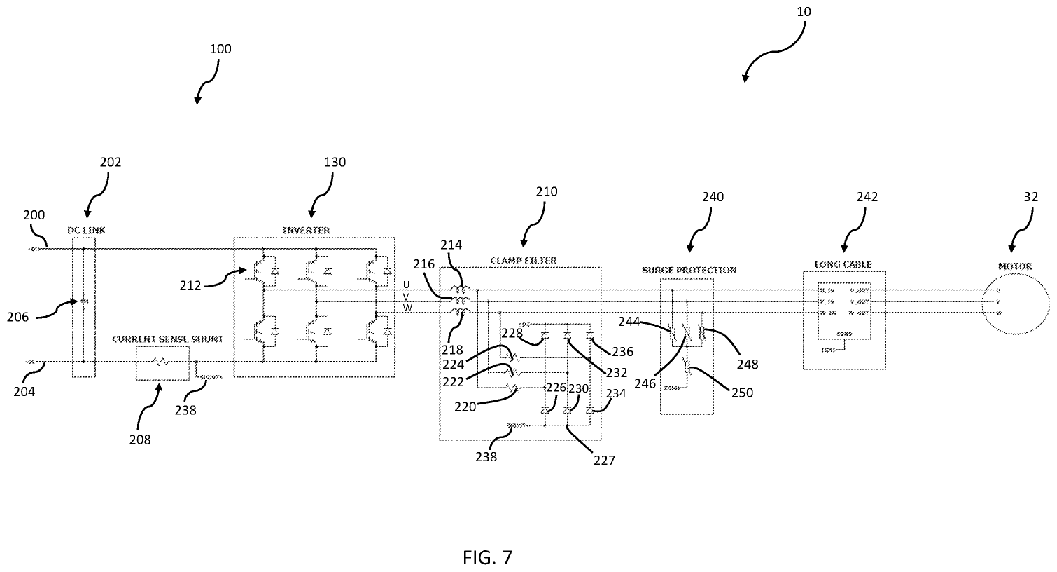

Rectifier 120 is powered by a power source 40 and includes any rectification circuit well known in the art, e.g., a diode bridge, to convert three phase alternating-current (AC) voltage supplied by power source 40 into direct-current (DC) voltage which it supplies, after smoothing, to inverter 130. As is known in the art, the rectifier 120 includes a plurality of diodes connected in parallel which allow the positive portions of the three phase AC voltage to pass to the load. Inverter 130 receives DC power from rectifier 120 through a conductor 122 and converts the DC power into an AC motor power. Power source 40 may comprise a single phase two-wire supply, a single phase three-wire supply, or a three-phase supply. A single phase two-wire supply is shown although a three-phase supply is described below with reference to FIG. 7.

CPU 104 receives inputs through an I/O interface 108 and outputs a control signal over line 128 to inverter 130. In one example, the control signal, e.g. speed reference, is provided to a pulse-width-modulated (PWM) module having power switches and control logic which generates the appropriate gating signals for the power switches to convert the DC power supplied by rectifier 120 to the AC motor voltage suitable to drive the motor according to the control signal, provided to the motor via conductors 132, 134. Current drawn by motor 32 from inverter 130 is sensed by a current sensor 123 and a current signal is provided by current sensor 123 to CPU 104 by conductor 124. Motor voltage feedback can also be provided, for example through conductor 126 connecting inverter 130 and controller 102. Motor voltages may also be generated with other known or later developed drive topologies programmed in accordance with embodiments of the disclosure.

In a more general embodiment, the controller comprises control logic operable to generate the control signal. The term “logic” as used herein includes software and/or firmware executing on one or more programmable processors, application-specific integrated circuits, field-programmable gate arrays, digital signal processors, hardwired logic, or combinations thereof. Therefore, in accordance with the embodiments, various logic may be implemented in any appropriate fashion and would remain in accordance with the embodiments herein disclosed. A non-transitory machine-readable medium comprising logic can additionally be considered to be embodied within any tangible form of a computer-readable carrier, such as solid-state memory, magnetic disk, and optical disk containing an appropriate set of computer instructions and data structures that would cause a processor to carry out the techniques described herein. A non-transitory computer-readable medium, or memory, may include random access memory (RAM), read-only memory (ROM), erasable programmable read-only memory (e.g., EPROM, EEPROM, or Flash memory), or any other tangible medium capable of storing information.

Referring now to FIG. 7, a circuit diagram for portions of a pump system 10 of the present disclosure is shown. It should be understood that while the description of embodiments of the present disclosure describes an inverter 130 that outputs an approximated three-phase AC output and a clamp filter 210 that includes a variety of components connected to each phase of the three-phase AC output, the present disclosure is not so limited. In other applications, the inverter 130 a single approximated AC output and the clamp filter 210 includes the variety of components described below connected to that single approximated AC output.

The power source 40 and the rectifier 120, shown in FIG. 6, and the pump 36, shown in FIG. 5, and other components of the system are omitted from the diagram of FIG. 7 to simplify the description. The rectified voltage from the rectifier 120 is provided on +DC line 200 to a DC link 202 and a common signal is provided on −DC line 204 to the DC link 202. In this example, the DC link 202 includes a capacitor 206 having one side coupled to the +DC line 200 and the other side coupled to the −DC line 204. The capacitor 206 functions to smooth the ripples on the rectified DC signal from the rectifier 120 to provide a substantially smooth, constant DC voltage to the inverter 130. A current sense shunt resistor 208 is also connected on one end to the −DC line 204. The other end 238 of the shunt resistor 208 is connected to the inverter 130 and to a clamp filter 210 as is further described below.

As indicated above, the inverter 130 includes six switches 212, e.g., IGBTs, which open and close in pairs to control the flow of current under control of the controller 102 to produce three phases (U, V and W) of approximated AC voltage sine waves for driving the motor 32. As is known, the controller 102 rapidly pulses the switches 212 using pulse width modulation to form output waveforms which closely approximate sine waves on the U, V and W phases of the inverter 130 output. By controlling the timing of the switches, the controller 102 controls the frequency of the output waveforms, which in turn controls the speed with which the motor 32 (and therefore the pump 36) operates.

The clamp filter 210 generally includes three inductors 214, 216, 218, three resistors 220, 222, 224, and six diodes 226, 228, 230, 232, 234, 236. The input side of the inductor 214 is connected to the U phase output of the inverter 130. The output side is connected to the U phase input of a surge protection circuit (“surge protector 240”) as is described below. Similarly, the input side of the inductor 216 is connected to the V phase output of the inverter 130, and the output side is connected to the V phase input of the surge protector 240. Finally, the input side of the inductor 218 is connected to the W phase output of the inverter 130, and the output side is connected to the W phase input of the surge protector 240.

The input side of the resistor 220 is connected to the output side of the inductor 214 and the output side is connected to the cathode of the diode 226 and the anode of the diode 228. The input side of the resistor 222 is connected to the output side of the inductor 216 and the output side is connected to the cathode of the diode 230 and the anode of the diode 232. Similarly, the input side of the resistor 224 is connected to the output side of the inductor 218 and the output side is connected to the cathode of the diode 234 and the anode of the diode 236. The cathodes of the diodes 228, 232 and 236 are connected to the +DC line 200. The anodes of the diodes 226, 230 and 234 are connected to a common point 227 for all three of the phases, and the common point 227 is connected to the end 238 of the shunt resistor 208.

Surge protector 240 includes four metal-oxide varistors connected in a hybrid-Y configuration to protect against transients coupled to the output cable 242 (which is connected to the motor 32) due to environmental conditions. In certain deep well applications, the cable 242 has a length of between approximately 25 and 1,000 feet. In other deep well applications, the cable 242 has a length of between 500 and 1,000 feet. In still other deep well applications, the cable 242 has a length of greater than 1,000 feet. The input side of the varistor 244 is connected the U phase input of the surge protector 240 and the U phase input of the output cable 242. The input side of the varistor 246 is connected to the V phase input of the surge protector 240 and the V phase input to the output cable 242. Similarly, the input side of the varistor 248 is connected to the W phase input of the surge protector 240 and the W phase input to the output cable 242. The output sides of the varistors 244, 246 and 248 are connected together and to the input side of the common varistor 250. The output side of the common varistor 250 is connected to earth ground. The U, V and W phase outputs of the output cable 242 are connected to the U, V and W phase inputs of the motor 32, respectively.

Thus, the present disclosure provides a variable frequency drive output filter topology to attenuate high voltage ring up and reflections developed at the U, V and W phase input terminals of the motor 32 suitable for deep well pump motor applications in which the output cable 242 from the motor drive 100 to the motor 32 is long. The topology of the clamp filter 210 consists of, for each motor phase, an inductor, a resistor and two clamping diodes. For protection against surge transients coupled to the output cable 240 due to environmental conditions, the hybrid-Y configuration surge protector 240 works in combination with the resistors of the clamp filter 210. The inverter emitter shunt resistor 208 is included to detect a clamping diode failure as is further described below.

The resistors 220, 222 and 224 of the clamp filter 210 each have a resistance value such that resistance, R, multiplied by the expected maximum surge current, Isurge, is greater than the clamp voltage, Vclamp, of the surge protector 240 varistors 244, 246 and 248 (i.e., R*Isurge>Vclamp). In one embodiment, the R is about 0.5 Ohms, Isurge is about 700 Apeak and Vclamp is within the range of about 330 V to about 545 V. The surge protector 240 together with the resistors 220, 222 and 224 limits the voltage and current applied to the clamp filter 210 protecting the diodes 226, 228, 230, 232, 234, 236. The inductors 214, 216 and 218 together with the surge protector 240, the clamp filter 210 and the resistors 220, 222 and 224 limits the current applied to the inverter 130, thereby protecting it. Further, the resistors 220, 222 and 224 as connected in FIG. 7 also provide filter damping.

As shown in FIG. 7, the diodes form diode bridges for each phase, each consisting of a pair of clamping diodes (i.e., diode 228 and diode 238, diode 232 and diode 230, and diode 236 and diode 234) connected between the +DC line 200 and the common point 227 and coupled to an output side of one of the resistors 220, 222 and 224. The common point 227 is coupled to the end 238 of the shunt resistor 208 to detect a diode failure. The diodes 226, 228, 230, 232, 234 and 236 are typically of an ultra-fast type to limit reverse recovery losses due to the high switching frequencies of the inverter 130. In other embodiments, other diode types may be used.

The surge protector 240 coupled to the clamp filter 210 protects against phase to earth ground and phase to phase surge transients coupled to the output. The configuration of the varistors 224, 246, 248 and 250 clamps the voltage output of the clamp filter 210 and, in certain embodiments, the resistor values selected allow the motor drive 100 to withstand up to 6,000 V surge transients on the output cable 242 without drive failure. The capacitance of the clamp filter 210 in the configuration shown is comprised of only the parasitic capacitance of the output cable 242. In certain embodiments, the clamp filter 210 has a target peak voltage at the terminals of the motor 32 of less than 1,000 V for any length of the output cable 242 between zero and 1,000 feet.

Any directional references used with respect to any of the figures, such as right or left, up or down, or top or bottom, are intended for convenience of description, and do not limit the present disclosure or any of its components to any particular positional or spatial orientation. Additionally, any reference to rotation in a clockwise direction or a counter-clockwise direction is simply illustrative. Any such rotation may be implemented in the reverse direction as that described herein.

Although the foregoing text sets forth a detailed description of embodiments of the disclosure, it should be understood that the legal scope of the invention is defined by the words of the claims set forth at the end of this patent and equivalents. The detailed description is to be construed as exemplary only and does not describe every possible embodiment. Numerous alternative embodiments may be implemented, using either current technology or technology developed after the filing date of this patent, which would still fall within the scope of the claims.

The following additional considerations apply to the foregoing description. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at various times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single device or geographic location (e.g., within a home environment, an office environment, or a server farm). In other example embodiments, the one or more processors or processor-implemented modules may be distributed across a number of devices or geographic locations.

Unless specifically stated otherwise, use herein of words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Additionally, some embodiments may be described using the expression “communicatively coupled,” which may mean (a) integrated into a single housing, (b) coupled using wires, or (c) coupled wirelessly (i.e., passing data/commands back and forth wirelessly) in various embodiments.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A pump system, comprising:
a power source;
a pump unit including a pump and a motor;
a motor drive disposed remotely relative to the pump unit; and
a cable connecting the motor drive to the motor;
the motor drive comprising:
a rectifier coupled to the power source and configured to convert alternating current (“AC”) voltage from the power source into a direct current (“DC”) output voltage having a +DC line and a −DC line;
an inverter coupled to the rectifier and configured to convert the DC output voltage of the rectifier into an approximated AC output voltage; and
a clamp filter coupled to the inverter configured to attenuate high voltage ring up and reflections developed at input terminals of the motor;
wherein the clamp filter includes for each phase of the approximated AC output voltage, an inductor, a resistor, a first diode having an anode and a cathode and a second diode having an anode and a cathode, the inductor having an input side connected to the AC output voltage and an output side connected to an input side of the resistor, the resistor having an output side connected to the cathode of the first diode and the anode of the second diode, the anode of the first diode of each phase being connected to a common point, and the cathode of the second diode being connected to the +DC line.

2. The pump system of claim 1, wherein the rectifier is configured to covert three-phase AC voltage from the power source.

3. The pump system of claim 1, wherein the inverter is configured to convert the DC output voltage of the rectifier into an approximated three-phase AC output voltage.

4. The pump system of claim 3, wherein the clamp filter includes, for each phase of the approximated three-phase AC output voltage, an inductor, a resistor, a first diode having an anode and a cathode and a second diode having an anode and a cathode, the inductor having an input side connected to one phase of the approximated three-phase AC output voltage and an output side connected to an input side of the resistor, the resistor having an output side connected to the cathode of the first diode and the anode of the second diode, the anode of the first diode of each phase being connected to the common point, and the cathode of the second diode being connected to the +DC line.

5. The pump system of claim 1, further comprising a surge protector connected between the clamp filter and the cable, the surge protector including a first metal oxide varistor having an input side connected to the output side of the inductor and an output side connected to an input side of a common metal oxide varistor, an output side of the common varistor being connected to earth ground.

6. The pump system of claim 5, wherein the resistor has a resistance value that when multiplied by an expected maximum surge current is greater than a clamp voltage of the surge protector.

7. The pump system of claim 1, further comprising a current sense shunt resistor having a first end connected to the −DC line and a second end connected to the common point of the clamp filter to detect a failure of at least one of the first diode and the second diode.

8. The pump system of claim 1, further comprising a capacitor having a first end connected to the +DC line and a second end connected to the −DC line, the capacitor being configured to smooth ripples on the DC output voltage of the rectifier.

9. The pump system of claim 1, wherein the pump unit is a deep well pump unit.

10. The pump system of claim 8, wherein the cable has a length of between approximately 25 feet and 1,000 feet.

11. A clamp filter for attenuating high voltage ring up and reflections in an output of a variable frequency drive for deep well pump applications where an output of the variable frequency drive is connected to a remote pump motor by a cable, the clamp filter comprising:
for each phase of an approximated AC output voltage of the variable frequency drive, an inductor, a resistor, a first diode having an anode and a cathode and a second diode having an anode and a cathode, the inductor having an input side connected to an AC output voltage of an inverter and an output side connected to an input side of the resistor, the resistor having an output side connected to the cathode of the first diode and the anode of the second diode, the anode of the first diode being connected to a common point, and the cathode of the second diode being connected to a +DC line.

12. The clamp filter of claim 11, wherein the inverter is configured to convert a DC output voltage of a rectifier into an approximated three-phase AC output voltage, and the clamp filter includes, for each phase of the approximated three-phase AC output voltage, an inductor, a resistor, a first diode having an anode and a cathode and a second diode having an anode and a cathode, the inductor having an input side connected to one phase of the approximated three-phase AC output voltage and an output side connected to an input side of the resistor, the resistor having an output side connected to the cathode of the first diode and the anode of the second diode, the anode of the first diode of each phase being connected to the common point, and the cathode of the second diode being connected to the +DC line.

13. The clamp filter of claim 11, further comprising a surge protector connected between the clamp filter and the cable, the surge protector including a first metal oxide varistor having an input side connected to the output side of the inductor and an output side connected to an input side of a common metal oxide varistor, an output side of the common varistor being connected to earth ground.

14. The clamp filter of claim 13, wherein the cable has a length of between approximately 25 feet and 1,000 feet.

15. The clamp filter of claim 13, wherein the resistor has a resistance value that when multiplied by an expected maximum surge current is greater than a clamp voltage of the surge protector.

16. The clamp filter of claim 11, further comprising a current sense shunt resistor having a first end connected to a −DC line and a second end connected to the common point of the clamp filter to detect a failure of at least one of the first diode and the second diode.

17. A deep well fluid pump system, comprising:
a deep well pump unit disposed in a well and including a pump and a motor;
a variable frequency drive disposed remotely relative to the pump unit; and
a cable connecting the variable frequency drive to the motor;
wherein the variable frequency drive comprises:
a rectifier;
an inverter coupled to the rectifier by a DC link and configured to produce an approximated AC output voltage;
a clamp filter coupled to the inverter;
a surge protector coupled between the clamp filter and the cable; and
a shunt resistor coupled between the DC link and the clamp filter;
wherein the clamp filter includes for each phase of the approximated AC output voltage, an inductor, a resistor, a first diode having an anode and a cathode and a second diode having an anode and a cathode, the inductor having an input side connected to the AC output voltage and an output side connected to an input side of the resistor, the resistor having an output side connected to the cathode of the first diode and the anode of the second diode, the anode of the first diode of each phase being connected to a common point, and the cathode of the second diode being connected to a +DC line of the DC link.

18. The deep well fluid pump system of claim 17, wherein the rectifier is coupled to a power source and configured to convert three-phase alternating current (“AC”) voltage from the power source into a direct current (“DC”) output voltage having the +DC line and a −DC line.

19. The deep well fluid pump system of claim 18, wherein the inverter is configured to convert the DC output voltage of the rectifier into an approximated three-phase AC output voltage.

20. The deep well pump system of claim 19, wherein the clamp filter includes, for each phase of the approximated three-phase AC output voltage, an inductor, a resistor, a first diode having an anode and a cathode and a second diode having an anode and a cathode, the inductor having an input side connected to one phase of the approximated three-phase AC output voltage and an output side connected to an input side of the resistor, the resistor having an output side connected to the cathode of the first diode and the anode of the second diode, the anode of the first diode of each phase being connected to the common point, and the cathode of the second diode being connected to the +DC line.

21. The deep well pump system of claim 18, wherein the shunt resistor has a first end connected to the −DC line of the DC link and a second end connected to the common point of the clamp filter to detect a failure of at least one of the first diode and the second diode.

22. The deep well pump system of claim 18, wherein the DC link includes a capacitor having a first end connected to the +DC line and a second end connected to the −DC line, the capacitor being configured to smooth ripples on the DC output voltage of the rectifier.

23. The deep well pump system of claim 17, wherein the surge protector includes a first metal oxide varistor having an input side connected to the output side of the inductor and an output side connected to an input side of a common metal oxide varistor, an output side of the common varistor being connected to earth ground.

24. The deep well pump system of claim 17, wherein the resistor has a resistance value that when multiplied by an expected maximum surge current is greater than a clamp voltage of the surge protector.

25. The deep well pump system of claim 17, wherein the cable has a length of between approximately 25 feet and 1,000 feet.
